(19) United States
(12) Patent Application Publication
(10) Pub. No.: US 2026/0356338 A1
(43) Pub. Date: Nov. 12, 2026

(54) BRAKE CONTROL VALVE WITH PRE-CONTROL UNIT

(71) Applicant: ZF CV Systems Europe BV, Brussels (BE)

(72) Inventors: Adam Lango, Wroclaw (PL); Leszek Toma, Radwanice (PL); Izabela Mikosiak, Wroclaw (PL)

(21) Appl. No.: 19/486,579

(22) PCT Filed: May 23, 2023
(86) PCT No.: PCT/EP2023/063742

§ 371 Date: Nov. 21, 2025

(51) Int. Cl. B60T 13/68; B60T 8/1761

(52) U.S. Cl. CPC B60T 13/683; B60T 8/1761

(57) ABSTRACT

A brake control valve (102; 302) includes a pneumatic pressure inlet port (120) receiving brake pressure representing a driver's brake demand pressure component, a relay valve (124) having a control port (122), an input port (116), and an output port (132). The relay valve (124) connects the input port (116) with the output port (132) based on control pressure at the control port. Output pressure of an electropneumatic pre-control unit (EPU1; EPU2) supplies the control pressure to the control port (122) of the relay valve (124). The pre-control unit (EPU1; EPU2) includes a solenoid valve (110) and a pressure operated unit (112; 304). The brake control valve may function as a rear axle modulator valve of an electropneumatic brake system of a commercial vehicle.

### FIELD

The present disclosure relates to a brake control valve for use in a commercial vehicle. The brake control valve, in particular, can be controlled electropneumatically i.e., with electronic and/or pneumatic control forces. In accordance with an embodiment, the brake control valve of the present disclosure is suitable to control wheel end brakes associated with either of the ends of an axle of the commercial vehicle. Said axle can preferably be a rear axle.

### BACKGROUND

Controlling the brake control valves electro-pneumatically is known in the art. In particular, the brake control valves are controllable through electronic devices to apply brakes of the vehicle. Should any of the components which enable the electronic control fail, it is envisaged that there should be a way to solely pneumatically control the brake control valves so that the intended brake demand originating from the driver's end can be implemented. Such fallback or redundancy approaches are known in the art and are part of legislative measures for controlling brake systems both in the past and present.

### SUMMARY

In accordance with an embodiment of the present disclosure, a brake control valve is disclosed. The brake control valve comprises a pneumatic pressure inlet port for receiving brake pressure reflecting a driver's brake demand pressure component, a relay valve comprising a control port, an input port and an output port, wherein, depending on control pressure received at the control port, the relay valve is configured to connect the input port with the output port; and an electropneumatic pre-control unit, wherein the output pressure of the electropneumatic pre-control unit is configured to supply the control pressure to the control port of the relay valve. In accordance with the present disclosure the electropneumatic pre-control unit comprises a solenoid valve and a pressure operated unit. The pressure operated unit comprises a reciprocating structure such that the pressure operated unit is configured to receive the brake pressure reflecting the driver's brake demand pressure component from the pneumatic pressure inlet port and the electropneumatic pressure component from the solenoid valve, and to supply the control pressure, which is either the brake demand pressure or the electropneumatic pressure, to the control port of the relay valve.

As can be taken from the above embodiment, only one of the pressure components—the pressure component reflecting the driver's brake demand, which can be derived directly from a brake signal transmitter, and the electropneumatic pressure component, which is primarily an Electronic Control Unit (ECU) driven component-is supplied to the control port of the relay valve. In particular, when such an arrangement is used as part of a rear axle valve modulator, it enables not only the braking at rear axle wheel-end brake actuators when a driver initiates it, but also automatic braking strategies including Anti-lock Braking System (ABS), traction control, wheel slip control, without direct reception of control from a driver. Furthermore, by ensuring at least one brake component i.e., the driver's brake demand or the electropneumatic pressure, the compliance requirements under various legislations can be satisfied withing the brake control valve.

In accordance with the same and/or different embodiment of the present disclosure, the brake control valve further comprises a first pneumatically operable inlet valve being connected to a brake actuator at its outlet and being connected to the output port of the relay valve at its inlet, a first electronically operable inlet control valve comprising an inlet, an outlet and an exhaust port, wherein the inlet of the first electronically operable inlet control valve is connected to the output port of the relay valve and its outlet is connected to a first control line of the first pneumatically operable inlet valve, and wherein, in an open state, the first electronically operable inlet control valve establishes a pneumatic connection between its inlet and its outlet, and in a closed state, the outlet of the first electronically operable inlet control valve is connected with the exhaust port, a first pneumatically operable outlet valve being connected to the brake actuator at its outlet and being connected to an exhaust or relief port at its inlet, and a first electronically operable outlet control valve comprising an inlet, an outlet and an exhaust port, wherein the inlet of the first electronically operable outlet control valve is connected to the output port of the relay valve and its outlet is connected to a second control line of the first pneumatically operable outlet valve.

Such an arrangement of the brake control valve, as explained in the previous paragraph, the brake control valve does not only enable it to be used in conjunction with the ABS systems where such electropneumatic brake control method is used to prevent wheel lock situations during the braking, but also enables combining a solenoid-actuated relay valve with ABS components. Thus, a modular or finely controlled brake strategy can not only be implemented at the solenoid valve whose output is connected to the relay valve control port (see above), but also can be implemented right at the wheel end i.e., one tier of control before the wheel end brake actuators.

In conjunction with the embodiment explained in the previous paragraphs, according to the present disclosure, the first pneumatically operable inlet valve includes a diaphragm, which closes the connection between its outlet and the exhaust port when there is pressure in the first control line, and wherein the first pneumatically operable outlet valve includes another diaphragm, which closes the connection between its outlet and the exhaust port when there is pressure in the second control line.

Some of the technical advantages of using the diaphragm are known in the art and are part of the regular Anti-lock braking systems. However, the usage of the diaphragm generally provides a sealing effect against the parts that they are assembled with, especially when the diaphragm is sandwiched between two housing parts.

In accordance with one or more of the above embodiments, the brake control valve further comprises a second pneumatically operable inlet valve being connected to another brake actuator at its outlet and being connected to the output port of the relay valve at its inlet, a second electronically operable inlet control valve comprising an inlet, an outlet and an exhaust port, wherein the inlet of the second electronically operable inlet control valve is connected to the output port of the relay valve and its outlet is connected to a third control line of the second pneumatically operable inlet valve, and wherein, in an open state, the second electronically operable inlet control valve establishes a pneumatic connection between its inlet and outlet, and in a closed state, the outlet of the second electronically operable inlet control valve is connected with the exhaust port, a second pneumatically operable outlet valve being connected to another brake actuator at its outlet and being connected to the exhaust or relief port at its inlet, and a second electronically operable outlet control valve comprising an inlet, an outlet and an exhaust port, wherein the inlet of the second electronically operable outlet control valve is connected to the output port of the relay valve and its outlet is connected to a fourth control line of the second pneumatically operable outlet valve.

The technical purpose of providing the arrangement as described in the previous paragraph is to combine the electropneumatic control at or before the wheel end actuator, in addition to providing solenoid valve-based control at the relay valve control port. This is provided at either end of the axle i.e., at two wheels. This also means that both the wheel end brake actuators present at either end of the axles enjoy the anti-lock braking control in addition to finely tuned modular control enabled at the solenoid valve of the electropneumatic pre-control unit.

Hence, the brake control unit cumulatively incorporating the features described in the previous paragraphs is ideal to be used as a rear axle valve modulator or rear axle valve package or rear axle brake modulator that can perform braking using the manual brake pressure received from the brake signal transmitter along with the electropneumatic control (received, preferably from the ECU) at either ends of the axle at different points in time.

In the same or different embodiments described above, the second pneumatically operable inlet valve includes a yet another diaphragm, which closes the connection between its outlet and the exhaust port when there is pressure in the third control line, and wherein the second pneumatically operable outlet valve includes a still another diaphragm (which is different from the diaphragm, the another diaphragm, and the yet another diaphragm mentioned above), which closes the connection between its outlet and the exhaust port when there is pressure in the fourth control line.

The brake control valve according to any one of the above-described embodiments, wherein the pressure operated unit includes at least one manual pressure receiving port at a first side of the pressure operated unit that is either directly or indirectly connected to a brake pressure outlet of the brake signal transmitter, and at least one electronically controlled pressure receiving port at a second side of the pressure operated unit, and wherein the pressure operated unit is configured such that the port which receives the pressure that is higher in magnitude is connected with the control port of the relay valve. This arrangement enables selecting one among the two pressure components to be used for operating the relay valve. One way to perceive this is, only the pressure component with a higher magnitude is allowed to control the relay valve. Another way to envisage the arrangement described in this embodiment is to allow the pressure component, which has reached the relay valve control port faster than the other pressure component (the manual brake pressure or the electropneumatic pressure component). Typically, the electropneumatic pressure component reaches faster than the manual pressure component because electronic signals can be quickly implemented across the brake circuits in comparison to the speed at which the pneumatic signals can be transferred. However, the provision of allowing the higher magnitude to be connected to the control port of the relay valve ensures that at least one component is used, regardless of how it reaches the control port of the relay valve. This provides safety as well as negligible perception of delay from the driver's end on applying the brakes.

The brake control valve according to any one of the above embodiments, wherein the pressure operated unit is a solely pneumatically operated valve with at least three ports and is configured to switch between two positions. The technical purpose of this is to confirm that at least two control ports—one for receiving the driver's brake demand or manual pressure component and the other for receiving the electropneumatic pressure component—and one output port that transmits the pressure to the control port of the relay valve.

In accordance with one or more embodiments disclosed above, the brake control valve enables an arrangement, wherein the pressure operated unit is a double check valve or a select-high valve. Double check valves and in particular, a select-high valve (as opposed to select-low valve), ensures that the port that receives the higher pressure moves any reciprocating structure of the pressure operated unit of the brake control valve.

In particular, the reciprocating structure of the pressure operated unit includes a shuttle that is configured to move and close the port receiving either the brake pressure reflecting the driver's brake demand or the electropneumatic pressure from the solenoid valve. The shuttle may enable non-sticking effect during the usage in that, it prevents locking itself in one position due to any effect that exists over a long duration of usage. Furthermore, the shuttle of the present disclosure can change its position even when the pressure difference between the two components is really small or miniscule such as 0.1 bar. Thus, even if the pressure source or the reservoir that supplies the pressure for the two different brake pressure components (the manual pressure component reflecting the driver's brake demand and the electropneumatic pressure component typically ECU directed) is the same or if the reservoir that supplies the pressure for these two brake pressure components is the same, the pressure operated unit with the shuttle would still be able to perform its function. In particular, this is the case when there is a slight delay in the arrival of the pressure at any one of the control or pressure receiving ports of the double check valve or pressure operated unit. In accordance with an exemplary embodiment, during the operation, wherein the shuttle closes one side of the actuation chamber.

In an alternative embodiment to the one where the double check valve or shuttle is used, the pressure operated unit is configured as a non-return valve and the reciprocating structure is an over-molded polymer component, wherein the non-return valve is configured to retain a last achieved position within the pressure operated unit, when the solenoid valve is in open position, and wherein, in the last achieved position, either the brake pressure reflecting the driver's brake demand from the pneumatic pressure inlet port or the electropneumatic pressure from the solenoid valve is connected to the control port of the relay valve.

In accordance with one or more of the above embodiments, wherein the brake control valve further includes a digital pressure sensor that is configured to provide pulse width modulated signals, and wherein the digital pressure sensor is positioned at the output port of the relay valve. Pulse width modulated signals for the pressure sensor provides for compliance according to “functional safety” requirements as per ISO standard 26262.

Furthermore, in the brake control valve according to any one of the above embodiments, the solenoid valve comprises an inlet port, a first intermediary chamber that receives the pressurized fluid from a fluid reservoir via the inlet port, a spring-supported member for closing and/or opening a valve port connected to the first intermediary chamber, a magnetic excitation coil configured to either directly or indirectly move the spring-supported member to close and/or open the valve port, and a second intermediary chamber being isolated from the first intermediary chamber when the spring-supported member is closing the valve port, and an exhaust port connected to the second intermediary chamber when the spring-supported member is closing the valve port, wherein the pressure operated unit includes an actuation chamber that can be connected to the second intermediary chamber, and wherein, when the first and second intermediary chambers are connected to each other in that when the pressurized fluid from the first intermediary chamber reaches the second intermediary chamber, the solenoid valve is configured such that the connection between the second intermediary chamber and the exhaust port is blocked.

In the same solenoid valve as explained in the previous paragraph, the actuation chamber is always connected with the second intermediary chamber.

In accordance with one or more embodiments of the present disclosure, the brake control valve further includes at least two non-modulated pressure outlets (a first and second non-modulated pressure ports), wherein the at least two non-modulated pressure outlets receive the brake pressure directly from the output port of the relay valve, preferably with no valves or flow obstructing devices present in a connecting line originating from the output port of the relay valve and ending at the at least two non-modulated pressure outlets. Said non-modulated pressure outlets enable the supply of unmodulated brake pressure directly to brake actuators. The technical advantage is to provide a duplicate connection that directly supplies the pressure to the brake actuators. If, for any reason, electronic control of solenoid valves that are associated with implementing the ABS control mode is not possible or even if the diaphragm based pressure operated pneumatic inlet and outlet valves should fail, the brake pressure still needs to reach the brake actuators, and the non-modulated pressure outlets of the present disclosure enable this.

It should be noted that, the brake control valve is particularly suitable to be used as a rear axle modulator valve dedicated to control the brakes of a rear axle of a vehicle. This is to specifically point out, the rear axle modular valve dedicated to control the brakes of the rear axle brakes need not necessarily be suitable to be used elsewhere in the brake system. For instance, a skilled person would not consider the brake control valve as described in the present disclosure to be a parking brake valve. But it is envisaged that the brake control valve can be part of the brake control valve system associated with the front axle brakes, insofar as the brake control valve used in conjunction of the front axle brakes benefits from having a relay valve, which is one of the features of the present disclosure.

In all the embodiments of the present disclosure, the brake control valve is envisaged that said valve can be a part of an electropneumatic brake system, preferably, an anti-lock brake system (ABS).

Furthermore, in an embodiment, the electropneumatic brake system includes a fluid reservoir that serves as a unified pressurized fluid source for both the driver's brake demand pressure and the electropneumatic pressure component.

Still furthermore, in accordance with an alternative embodiment. the electropneumatic brake system further includes a first fluid reservoir and a second fluid reservoir, wherein the first fluid reservoir serves as the pressurized fluid source for the driver's brake demand pressure component received directly from a brake signal transmitter at the pneumatic pressure inlet port and the second fluid reservoir serves as the pressurized fluid source for the electropneumatic pressure component received from the solenoid valve.

In the same embodiment of the electropneumatic brake system as explained in the previous paragraph, wherein the magnitude of pressure of the pressurized fluid stored in the first fluid reservoir is different than the magnitude of the pressurized fluid stored in the second fluid reservoir. Preferably, the electropneumatic brake system as explained herein, wherein the magnitude of pressure of the pressurized fluid stored in the second fluid reservoir is higher than the magnitude of pressure of the pressurized fluid stored in the first reservoir.

### BRIEF DESCRIPTION OF THE DRAWINGS

FIG. 1 shows a schematic view of an electropneumatic brake system in accordance with a first embodiment of present disclosure;

FIG. 2 shows a partial cross-sectional view an electropneumatic pre-control unit (EPU) as a part of a brake control valve in accordance with the first embodiment of the present disclosure;

FIG. 3 shows a schematic view of an electropneumatic brake system in accordance with a second embodiment of a present disclosure; and

FIG. 4 shows a partial cross-sectional view of an electropneumatic pre-control unit (EPU) as a part of a brake control valve in accordance with the second embodiment of the present disclosure.

### DETAILED DESCRIPTION

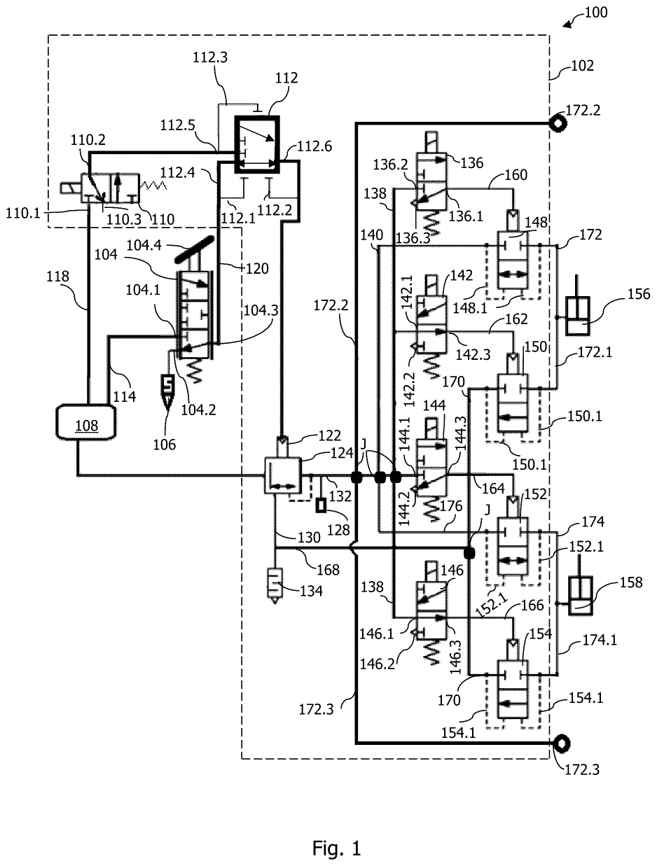

FIG. 1 shows a schematic view of an electropneumatic brake system 100 in accordance with a first embodiment of a present disclosure. As shown in FIG. 1, electropneumatic brake system 100 includes a brake control valve 102 (marked with the dotted line in FIG. 1; components falling within this dotted line can form brake control valve 102), a pressurized fluid source or a fluid reservoir 108, and a brake signal transmitter or generator 104. It should be noted that the terms “brake signal transmitter” or “brake signal generator” or “foot brake valve” and such refers to devices that are configured to receive a driver's brake demand provided via a pedal 104.4.

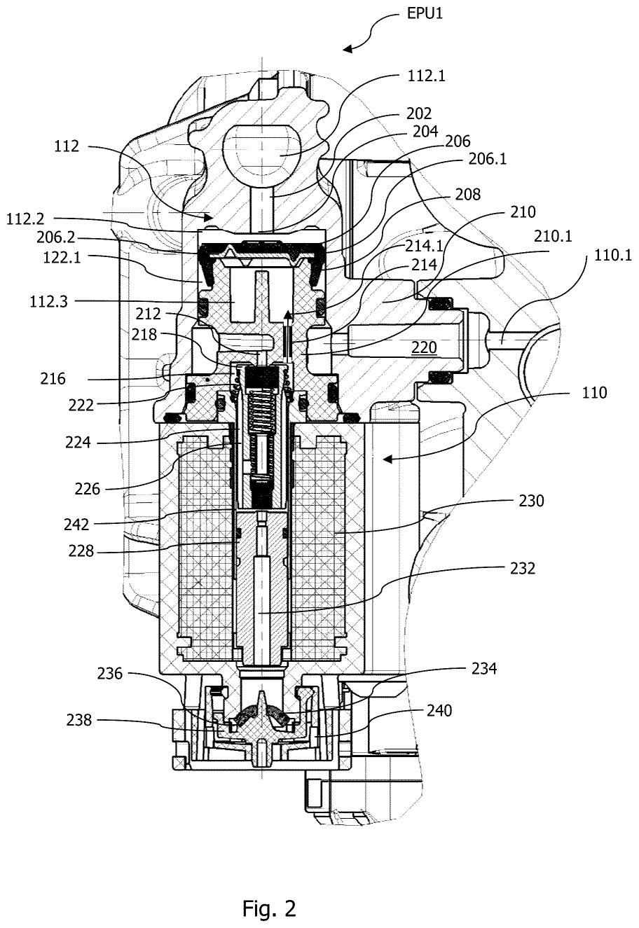

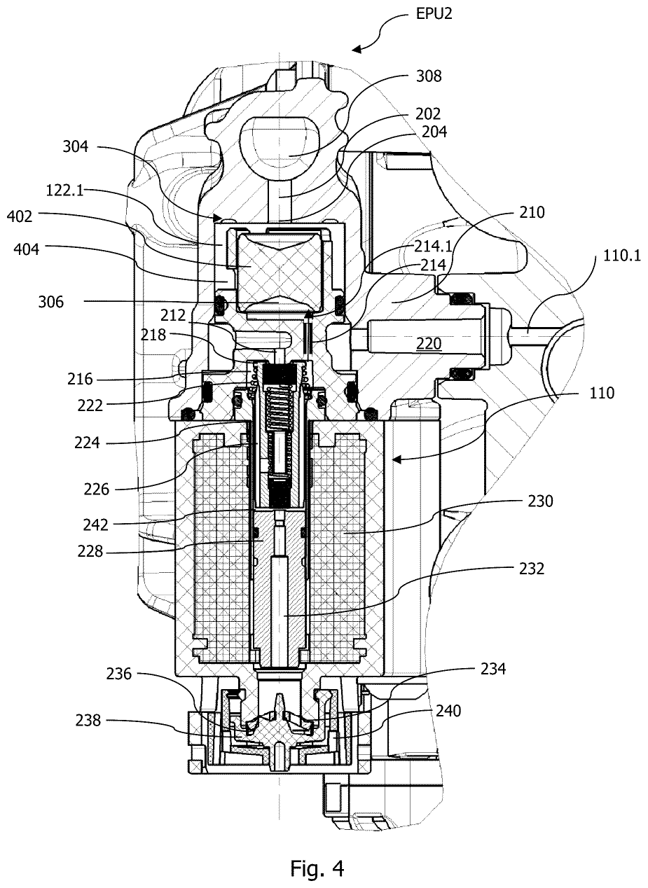

In accordance with the present embodiment, brake control valve 102, which includes a pneumatic pressure inlet port 120 receiving brake pressure reflecting a driver's brake demand, a relay valve 124 including a control port 122, an input port 116 and an output port 132, wherein, depending on control pressure received at control port 122, relay valve 124 is configured to connect input port 116 with its output port 132. Brake control valve 102 further includes an electropneumatic pre-control unit EPU1 wherein the output pressure of electropneumatic pre-control unit EPU1 is configured to supply the control pressure to control port 122 of relay valve 124. Electropneumatic pre-control unit EPU1 includes a solenoid valve 110 and a pressure operated unit 112. Pressure operated unit 112 includes a reciprocating structure (not shown in FIG. 1, but see e.g., reference sign “206” in FIG. 2 or “402” in FIG. 4) such that pressure operated unit 112 is configured to receive the brake pressure reflecting the driver's brake demand from pneumatic pressure inlet port 120 and (at the same time and/or additionally) the electropneumatic pressure from solenoid valve 110, and to supply the control pressure, which is either the brake demand pressure or the electropneumatic pressure, to control port 122 of relay valve 124.

Thus, by providing pressure operated unit 112 as shown in FIG. 1, the pressure component that is one of the driver's brake demand pressure arriving via port 120 and/or brake signal transmitter 104 and the electropneumatic pressure received from solenoid valve 110 is provided at control port 122 and/or at a control chamber (not shown in FIG. 1) of relay valve 124. This has an inherent technical advantage in that, should there be any failure in the electronic components that control the supply of pressure via solenoid valve 110, an alternative source of the control pressure is always made available at the control chamber of relay valve 124, thereby enabling not only the fulfillment of legislative requirements regarding the braking in some jurisdictions, but also providing a redundant control pressure to relay valve 124. Furthermore, even if the failure of any electronic component goes undetected by system 100, purely based on the functioning of pressure operated unit 112, the driver's brake demand pressure can be supplied as is i.e., without any loss of pressure or substantial delay. This secures the minimum functioning of braking by engaging e.g., brake actuators 156 and 158 at the wheel end and consequently, fulfilling the legislative requirements of one or more jurisdictions.

Furthermore, brake control valve 102 of the present disclosure (any and/or all of the embodiments) further includes a first pneumatically operable inlet valve 148 being connected to brake actuator 156 at its outlet and being connected to output port 132 of relay valve 124 at its inlet. In general, such first pneumatically operable inlet valve 148 is provided at wheel end brake actuators such as 156 to enable direct “ON/OFF” configuration, and that too, based on a control method using pneumatic pressure source.

Still furthermore, brake control valve 102 of the present disclosure includes a first electronically operable inlet control valve 136 including an inlet 136.2, an outlet 136.1 and an exhaust port 136.3, wherein inlet 136.2 of first electronically operable inlet control valve 136 is connected to output port 132 of relay valve 124 and its outlet 136.1 is connected to a first control line 160 of first pneumatically operable inlet valve 148, and wherein, in an open state, first electronically operable inlet control valve 136 establishes a pneumatic connection between its inlet 136.2 and outlet 136.1, and in a closed state, outlet 136.1 of first electronically operable inlet control valve 136 is connected with exhaust port 136.3.

Brake control valve 102 also additionally includes a first pneumatically operable outlet valve 150 being present between brake actuator 156 and an exhaust port, which may be referred to as relief port 134, wherein on activation enables connection between brake actuator 156 and relief port 134, and a first electronically operable outlet control valve 142 including an inlet 142.1, an outlet 142.3 and an exhaust port 142.2, wherein inlet 142.1 of first electronically operable outlet control valve 142 is connected to output port 132 of relay valve 124 and its outlet 142.3 is connected to a second control line 162 of first pneumatically operable outlet valve 150.

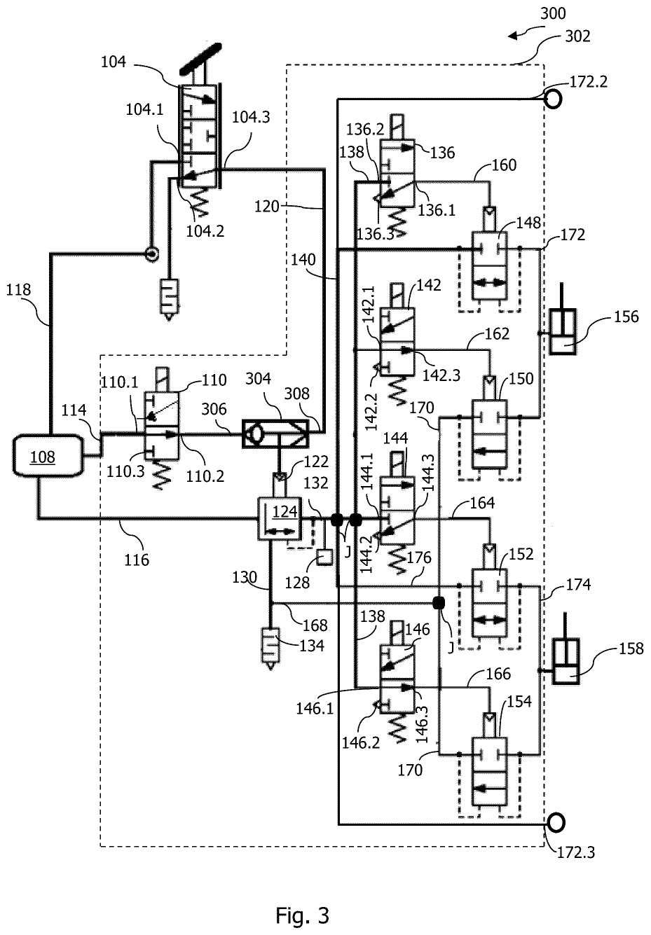

Hence, pneumatically operable inlet and outlet valves such as 148 and 150 as illustrated in FIG. 1 are relatively easy to construct and are part of Anti-Lock Braking System (ABS) that are capable of being used in commercial vehicle braking systems. Hence, first electronically operable inlet and outlet control valves 136 and 142 provide in combination with pneumatically operable inlet and outlet valves such as 148 and 150 a finely modulated pressure control when, for instance, wheel end brake actuator 156 needs to be precisely controlled for wheel slip prevention. Furthermore, by providing pneumatically operable inlet and outlet valves 148 and 150 in the manner as illustrated in FIG. 1 (also in FIG. 3), said valves can be configured to retain a default position that needed to be assumed for enabling at least one safety feature. For instance, when there is any failure in an electronic component, it could be necessary to enable purely pneumatic pressure control. In such a case, as can be seen in FIG. 1, for instance, a first pilot control line 148.1 is connected to line 140 that is connected to output port 132 of relay valve 124 and/or line 172 leading to brake actuator 156. If there is no control pressure at line 160, the pressure from line 140 and/or from line 172 will move valve 148 from closed to open position and the desired brake pressure will reach wheel end brake actuator 156. Similar to valve 148, first pneumatically operable outlet valve 150 also includes a second pilot control line 150.1 connected to line 170 that leads to relief port 134 and/or to line 172.1 that leads to brake actuator 156. This enables first pneumatically operable outlet valve 150 to retain its default position e.g., of being closed since one side of valve 150 that is connected to pilot control line 150.1 is always connected to atmosphere via relief port 134.

Thus, a combination of the electronically operable inlet and outlet valves along with the pneumatically operable inlet and outlet valves provide a design flexibility in use, in that, when a finely modulated electronic control such as wheel slip control is not possible, at the least, the driver's brake demand reaches the wheel end brake actuators.

The above-mentioned mode of working is enabled because of a particular design variation within the ABS, wherein first pneumatically operable inlet valve 148 includes a diaphragm, which closes the connection between output port 132 of relay valve 124 and brake actuator 156 when there is no pressure in first control line 160, and wherein first pneumatically operable outlet valve 150 includes a diaphragm, which closes the connection between brake actuator 156 and relief port 134 when there is pressure in second control line 162. In short, first electronically operable inlet and outlet control valves 136 and 142 act as a pilot control for the diaphragms of first pneumatically operable inlet valve 148 and first pneumatically operable outlet valve 150. Naturally, such a configuration with the diaphragm allows variety of technical advantages in that without the lack of pressure beyond a certain threshold, dislodging the diaphragm from its valve seat would not be possible, which provides a certain level of safety against false activation of the pneumatically controlled valves at the wheel end areas. Furthermore, as could be envisaged by a skilled person, the diaphragms also generally provide a sealing effect against the parts that they are assembled with, especially when the diaphragm is sandwiched between two housing parts. For instance, EP3494018A1 discloses some of the modes in which a diaphragm of an ABS valve is sandwiched between the two housing parts.

In the same embodiment, brake control valve 102 further includes a second pneumatically operable inlet valve 152 which is connected to another brake actuator 158 at its outlet and being connected to output port 132 of relay valve 124 at its inlet, a second electronically operable inlet control valve 144 including an inlet 144.1, an outlet 114.3 and an exhaust port 144.2, wherein inlet 144.1 of second electronically operable inlet control valve 144 is connected to output port 132 of relay valve 124 and its outlet 144.3 is connected to a third control line 164 of second pneumatically operable inlet valve 152, and wherein, in an open state, second electronically operable inlet control valve 144 establishes a pneumatic connection between its inlet 144.1 and outlet 144.3, and in a closed state, outlet 144.3 of second electronically operable inlet control valve 144 is connected with exhaust port 144.2, a second pneumatically operable outlet valve 154 present between brake actuator 158 and relief port 134, and a second electronically operable outlet control valve 146 including an inlet 146.1, an outlet 146.3 and an exhaust port 146.2, wherein inlet 146.1 of second electronically operable outlet control valve 146 is connected to output port 132 of relay valve 124 and its outlet 146.3 is connected to a fourth control line 166 of second pneumatically operable outlet valve 154. The technical advantage as explained above in relation to first pneumatically operable inlet valve 148, first electronically operable inlet control valve 136, first pneumatically operable outlet valve 150, and first electronically operable outlet control valve 142 are applicable here as well.

In accordance with the present embodiment, second pneumatically operable inlet valve 152 includes a diaphragm, which closes the connection between output port 132 of relay valve 124 and brake actuator 158 when there is no pressure in third control line 164, and wherein second pneumatically operable outlet valve 154 includes a diaphragm, which closes the connection between brake actuator 156 and relief port 134 when there is pressure in fourth control line 166. Furthermore, second pneumatically operable inlet valve 152 includes a third pilot control line 152.1 and second pneumatically operable outlet valve 154 includes a fourth pilot control line 154.1. Third pilot control line 152.1 is connected to line 176 and/or line 174 leading to brake actuator 158, which in turn is connected to output port 132 of relay valve 124 whereas fourth pilot control line 154.1 is connected to line 170 leading to relief port 134 and/or line 174.1 that leads to brake actuator 158. Pilot control lines 152.1 and 154.1 assist in retaining valves 152 and 154 in their respective default positions.

In accordance with the present disclosure, pressure operated unit 112 includes at least one manual pressure receiving port 112.1 or 112.2 at a first side of pressure operated unit 112 that is either directly or indirectly connected to a brake pressure outlet 104.3 of brake signal transmitter 104 or to control port 122 of relay valve 124, and at least one electronically controlled pressure receiving port 112.3 at a second side of pressure operated unit 112, and wherein pressure operated unit 112 is configured such that the port or ports which receive or receives the pressure that is higher in magnitude is connected with control port 122 of relay valve 124. In the first embodiment, two sides of pressure operated unit 112 are to be understood as lateral sides of unit 112 shown in FIG. 1. By providing two separate sides for receiving the control pressure components at pressure operated unit 112, the sources of pressure components are provided to move pressure operated unit 112 to either of the displayed positions in FIG. 1.

As can be seen, port 104.3 of brake signal transmitter 104 can be connected to port 112.4 as well as port 112.1 of pressure operated unit 112. In simple terms, port 112.1 branches out from line 120 which connects with port 104.3 of brake signal transmitter 104. Furthermore, the same side of pressure operated unit 112 where port 112.1 is connected to, also connects with control port 122 and/or a control chamber (not shown in FIG. 1) of relay valve 124 via port 112.2. Thus, even if there is no pressure at the side of pressure operated unit 112 where port 112.3 leading from port 110.2 of solenoid valve 110 present, the pressure from brake signal transmitter 104 can reach control port 122 via line 120, then port 112.1 which branches out from line 120, then via port 112.2.

Alternatively and/or additionally, due to the presence of pressure at port 112.1, pressure operated unit 112 moves to a position, whereby pressure from line 120 is connected to port 112.6 of pressure operated unit 112 via port 112.4. This results in pressure from line 120 reaching control port 122 of relay valve 124. Consequently, pressure operated unit 112 is designed or configured such that pressure operated unit 112 is a solely pneumatically operated valve with at least three ports 112.4, 112.5, 112.6, 112.1, 112.2, 112.3 and is configured to switch between two positions.

Furthermore, in a preferred or optional embodiment, brake control valve 102 further includes a digital pressure sensor 128 that is configured to provide pulse width modulated signals, and wherein digital pressure sensor 128 is positioned at output port 132 of relay valve 124. Pulse width modulated signals increase the safety of the overall device and provide more precise pressure signals.

Still furthermore, as shown in FIG. 1, a fluid reservoir 108 is provided that serves as a pressurized fluid source for both the driver's brake demand pressure and the electropneumatic pressure. This is only for illustrating that it is possible to use a single pressurized fluid source for operating the entirety of brake control valve 102. In an alternative embodiment, it is possible that there are two fluid reservoirs provided, wherein one of them serves as a pressurized fluid source for the electropneumatic pressure component leaving solenoid valve 110 and the other serves as a pressurized fluid source for brake signal transmitter 104.

In the following passages, general working principle of electropneumatic system 100 in accordance with the first embodiment will be explained.

When the driver presses pedal 104.4 downwards, the driver's brake demand is reflected in the pressure exiting via port 104.3 i.e., a connection between port 104.1 and port 104.3 is established. Note that port 104.1 of brake signal transmitter 104 receives supply pressure from fluid reservoir 108 through line 118.

At the same time, it is conceivable that, brake signal transmitter 104 includes an electronic pedal sensor (not shown in FIG. 1 or FIG. 3) which is configured to convert the driver's demand received via pedal 104.4 to an electronically readable data. For instance, PCT application bearing PCT/EP2022/058614 discloses one such sensor which uses the stroke length determined via a magnetically activated circuit as an indicator for the driver's brake demand.

In any case, pedal sensors using different physical values such as force, pressure, electromagnetic change, angle of pedal rotation and the like are known in the art. The output from the pedal sensor of brake signal transmitter 104 is then transferred to an Electronic Control Unit (ECU) (not shown in the figures) that is configured to control the braking operations of the electropneumatic system of the present disclosure.

The ECU thereafter controls the solenoids of different valves of the electropneumatic system. For instance, depending on the reading from the pedal sensor, the ECU controls solenoid valve 110 from its closed position (c.f. FIG. 1) where port 110.1 is disconnected from port 110.2 to an open position where ports 110.1 and 110.2 are connected with each other. The pressure from port 110.2 is supplied to ports 112.5 and 112.3, which moves pressure operated unit 112 to the position where pressure from solenoid valve 110 via port 110.2 reaches outlet port 112.6 of pressure operated unit 112. This means, the pressure received from fluid reservoir 108, passes through ports 110.1 and 110.2 at solenoid valve 110, thereafter through ports 112.4 and 112.6 at pressure operated unit 112 and finally reaches control port 122 of relay valve 124. However, the position displayed in FIG. 1 can be considered a default position of solenoid valve 110, wherein its inlet port 110.1 deriving pressurized fluid from fluid reservoir 108 is disconnected from port 110.2.

In any case, once relay valve 124 is activated by the pressure at control port 122, the fluid connection between input port 116 and output port 132 is established. Thereafter, from output port 132 of relay valve 124, and via line 140 and line 176, first and second pneumatically operable inlet valves 148 and 152 are supplied with the output pressure from relay valve 124.

Subsequently, the ECU controls first electronically controllable inlet valve 136 and/or second electronically controllable inlet valve 144 into open positions whereby ports 136.2 and 136.1 as well as ports 144.1 and 144.3 are connected with each other. This means, there is control pressure in lines 160 and 164 such that valves 148 and 152 can be moved into open and/or closed position. Subsequently, the pressure for actuating wheel end brakes reaches brake actuators 156 and 158 when pneumatically operated inlet valves 148 and 152 are in open position. These steps are performed to apply brake pressure at brake actuators 156 and 158.

In order to maintain the pressure within actuators 156 and 158 and/or keep brake actuators 156 and 158 in an extended state, the ECU controls valves 136 and 144 to a closed position, whereby port 136.1 of valve 136 and port 144.4 of valve 144 are connected to exhaust via ports 136.3 and 144.2, respectively. This state of actuation is shown in FIG. 1. In addition to closing inlet valves 148 and 152, outlet valves 150 and 154 are also moved to closed positions, by activating electronically controllable outlet valves 142 and 146. This means, no pressurized air enters or exits brake actuators 156 and 158. In such a state, since no pressure is allowed to be released from brake actuators 156 and 158, the brake is continuously applied.

In order to release the brake pressure from the actuators 156 and 158, electronically controllable outlet valves 142 and 146 should be moved to an exhaust state such that port 142.3 is connected to 142.2 and port 146.3 is connected to port 146.2. This is non-actuated state of valves 142 and 146 as shown in FIG. 1. Consequently, in the exhaust state of valves 142 and 146, the control pressure from lines 162 and 166 is removed, whereby the pressure from lines 172 and 174.1 are exhausted via open outlet valves 150 and 154 so that the pressure finally reaches relief port 134 through lines 170, 168.

By turning ON and OFF electronically operable inlet and outlet valves 136, 144, and 142 and 154, the brake pressure reaching wheel end brake actuators 156 and 158 is finely modulated for precise brake control because closed and open positions of pneumatically operated inlet and outlet valves 148, 152, and 150 and 154 are controlled. While pneumatically operated inlet valves 148 and 152 are connected at their inlets to output port 132 of relay valve 124, pneumatically operated outlet valves 150 and 154 are connected to relief port 134.

In accordance with one or more embodiments of the present disclosure, brake control valve 102 at least two further ports that supply unmodulated brake pressure from outlet port 132 of relay valve 124. These ports are marked as 172.2, a first non-modulated pressure outlet and as 172.3, a second non-modulated pressure outlet. Ports 172.2 and 172.3 are part of brake control valve 102 visible from the exterior or the housing and are provided with a direct connection to outlet port 132 of relay valve 124. Furthermore, first and second non-modulated pressure outlets 172.2 and 172.3 bypass or circumvent valves 136, 142, 144, 146, 148, 150, 152, and 154 as can be derived from FIG. 1. In particular, they enable, as mentioned above, the supply of unmodulated brake pressure directly to brake actuators 156 and 158. The technical advantage is to provide a duplicate connection that directly supplies the pressure to brake actuators 156 and 158. If, for any reason, electronic control of solenoid valves such as 136, 142, 144, and 146 is not possible, the brake pressure still needs to reach the brake actuators, and first and second non-modulated pressure outlets 172.2 and 172.3 provide this.

Moving to FIG. 2 which shows a partial cross-sectional view of electropneumatic pre-control unit EPU1 as a part of brake control valve 102 in accordance with the first embodiment.

The illustrated partial cross-sectional view of electropneumatic pre-control unit EPU1 shows, in particular how solenoid valve 110 and pressure operated unit 112 work within the context of the present disclosure.

Solenoid valve 110 includes inlet port 110.1, a first intermediary chamber 220 that receives the pressurized fluid from fluid reservoir 108 via inlet port 110.1, and a spring-supported member 218 for closing and/or opening a valve port 212 connected to first intermediary chamber 220. For instance, as can be taken from FIG. 2, first intermediary chamber 220 lies in the space that is enclosed by a housing 210 and an insert 210.1, and valve port 110.1 is part of insert 210.1 and is connected to first intermediary chamber 220.

Solenoid valve 110 further includes a magnetic excitation coil 230 configured to either directly or indirectly move spring-supported member 218 to close and/or open valve port 212. For instance, it is possible that spring-supported member 218 is made of a magnetizable material and when magnetic excitation coil 230 is excited with the help of electrical energy, spring-supported member 218 is configured to move downwards against the holding force exerted by a spring 222. Consequently, a second intermediary chamber (216), a part of solenoid valve 110, which was isolated from first intermediary chamber 220 when spring-supported member 218 was closing valve port 212, is now connected with first intermediary chamber 220.

Solenoid valve 110 further includes an exhaust port 232 connected to second intermediary chamber 216 when spring-supported member 218 is closing valve port 212, wherein pressure operated unit 112 includes an actuation chamber or port 112.3 that can be connected to second intermediary chamber 216, and wherein, when first and second intermediary chambers 220 and 216 are connected to each other in that when the pressurized fluid from first intermediary chamber 220 reaches second intermediary chamber 216, solenoid valve 110 is configured such that the connection between second intermediary chamber 216 and exhaust port 232 is blocked.

Furthermore, in accordance with the first embodiment of the present disclosure, pressure operated unit 112 is configured as a non-return valve and the reciprocating structure as mentioned above is an over-molded polymer component 206, wherein the non-return valve is configured to retain a last achieved position within pressure operated unit 112, when solenoid valve 110 is in open position, and wherein, in the last achieved position, either the brake pressure reflecting the driver's brake demand from pneumatic pressure inlet port 120 or the electropneumatic pressure from solenoid valve 110 is connected to control port 122 of relay valve 124.

In order to explain the above features in the context of the present disclosure, a general working principle of EPU1 is provided in the following passages. To the extent, the working principle of solenoid valve 110 is explained herewith, it is also applicable for the explanation in relation to e.g., FIG. 4.

As can be taken from FIG. 2, supply or inlet port 110.1 provided at the right-hand side of the drawing is connected either directly or indirectly to or with fluid reservoir 108 (see FIG. 1) for receiving the supply pressure that is necessary for the working of electropneumatic pre-control unit EPU1 before control pressure reaches relay valve 124 (see FIG. 1).

The received supply pressure is thereafter temporarily maintained in first intermediary chamber 220. This pressure is prevented from entering second intermediary chamber 216 by spring 222 and spring-supported member 218. For instance, spring-supported member 218 may include a vulcanized rubber provided at its center region. This vulcanized rubber is part of a valve seat (not marked in the figures) that contacts and closes valve port 212. Thus, due to upward force exerted by spring 222, spring-supported member 218 closes port 212 and thereby, disengages first and second intermediary chambers 220 and 216.

In the disengaged state where no pressure enters second intermediary chamber 216 from first intermediary chamber 220, the pressure (if any) present within first intermediary chamber 220 is exhausted via a gap 226 formed between spring-supported member 218 and an inner wall 224 and thereafter, reaching the space at region 242 and then via exhaust path formed via elements 232 and 240. It should be noted that second intermediary chamber 216 is connected with actuation chamber or port 112.3 of pressure operated unit 112 through a connecting port 214, which is schematically marked in FIG. 2. Thus, actuation chamber or port 112.3 along with second intermediary chamber 216 are exhausted when solenoid valve 110 is in the disengaged state with no excitation current at magnetic excitation coil 230. It should also be noted that element 232 is part of an exhaust path. The pressurized air exiting via path 232 momentarily encounters a flexible ingress protection membrane 234, which curves or bends due to impinging pressurized air and enables a connection between path 232 and an exhaust chamber 236 formed as a part of an exhaust cap 238. Exhaust cap 238 however has pores 240 through which the air escapes to the atmosphere.

As the ECU sends an electronic signal to excite magnetic excitation coil 230 using excitation current, spring-supported member 218 is displaced from its position of closing valve port 212 against the upward force exerted by spring 222. Hence, any remaining space as indicated at region 242 is closed due to the downward movement of spring-supported member 218 when there is excitation current at magnetic excitation coil 230. As a result, the supply pressure received via inlet port 110.1 passes via valve port 212 to move from first intermediate chamber 220 to second intermediate chamber 216. Thereafter, this pressure reaches actuation chamber or port 112.3 from second intermediate chamber 216 flowing in direction as indicated by arrow mark 214.1 at port 214.

Filling of actuation chamber 112.3 with the pressurized air moves over-molded polymer component 206 towards a manual pressure port 202 and closes its valve seat 204. For instance, in the present illustration of FIG. 2, it can be noticed that a polymer component 206.1 is molded over a plate 206.2. Component 206.1 and plate 206.2 form over-molded polymer component 206. In any case, as port 202 is closed, no pressure from manual pressure receiving port 112.1 can enter region 112.2 (manual pressure receiving port) as well.

Hence, the pressure builds within actuation chamber or port 112.3 to a threshold. After this threshold, a lip 208 which is formed as port of polymer component 206.1 lifts itself and a gap is formed between outer surfaces of insert 210.1 and polymer component 206.1 at the region where lip 208 is present. This entails the pressure from actuation chamber or port 112.3 entering a relay valve control port chamber 122.1 connected directly to control port 122 (not shown in FIG. 2, but see FIG. 1, for instance) of relay valve 124. This pressure actuates relay valve 124. Thus, the electropneumatic pressure component actuates relay valve 124 in the present case. It should be noted that relay valve control port chamber 122.1 may not be part of the relay valve in itself, but chamber 122.1 can be functionally connected to a control chamber of the relay valve.

On the other hand, when there is no electronic signal from the ECU to excite magnetic excitation coil 230, then there is no pressure in actuation chamber 112.3 as it is connected to exhaust (see the explanation above) via the path generated through port 214, and then to chamber 216, and then to gap 226, as well as region 242, and finally to exhaust path 232 and 240. This means, over-molded polymer component 206 does not close manual pressure port 202 anymore. Hence, if due to any reason, the electropneumatic pressure cannot be sent, the manual pressure reaches via port 202 directly from brake signal transmitter 104 and lifts over-molded polymer component 206 from manual pressure port valve seat 204. The manual control pressure received from brake signal transmitter 104 via port 202 fills chamber 122.1 and/or region 112.2 (manual pressure receiving port), which is directly connected to control port 122 of relay valve 124. In the present case, consequently, manual pressure actuates relay valve 124.

Moving on to FIG. 3, a schematic view of electropneumatic brake system 300 in accordance with a second embodiment of a present disclosure is shown. Electropneumatic brake system 300 includes brake control valve 302 of the second embodiment. Brake control valve 302 is marked with a dotted line in FIG. 3 just like brake control valve 102 is marked with a dotted line in FIG. 1 to indicate which components or elements are part of the respective brake control valve(s).

To the extent same reference signs are used for elements that are present in FIG. 3 as well as in at least one of FIGS. 1 and 2, the explanation provided in relation to FIGS. 1 and 2 are applicable here as well. In other words, for the elements commonly present between FIG. 1 and FIG. 3, the reference is provided to the detailed description above in relation to FIG. 1 to avoid repetition.

The difference between electropneumatic brake system 100 of FIG. 1 of the first embodiment and electropneumatic brake system 300 of FIG. 3 of the second embodiments lies in pressure operated unit 304. Instead of pressure operated unit 112 of FIGS. 1 and 2, pressure operated unit 304 of the second embodiment is configured to function as a “double check valve” or a select-high valve. By this way, whichever port has higher pressure among ports 306 and 308 is connected with control port 122 of relay valve 124. In contrast, pressure operated unit 112 of the first embodiment of FIGS. 1 and 2 is configured as a non-return valve, wherein the non-return valve is configured to retain a last achieved position within pressure operated unit 112. Consequently, if there is no pressure at one of the sides of pressure operated unit 112, the last position in which pressure operated unit 112 operated will be retained as long as no activation pressure is received at said one of the sides of pressure operated unit 112. Pressure operated unit 304 of FIGS. 3 and 4 does not retain the last operated position, it merely enables connection based on the pressure magnitude difference.

Furthermore, FIG. 3 illustrates the position of solenoid valve 110 where its inlet port 110.1 is connected with outlet port 110.2, which means solenoid valve 110 is activated by the ECU or the default position of solenoid valve 110 is overcome by the activation of the ECU. In accordance with all or one or more embodiments of the present disclosure, solenoid valve 110 is controlled by the ECU to implement or realize an automatic or automated traction control (ATC) mode of working of the brake system. Through ATC mode of working, advanced controlling of the brake system can be executed to prevent many drawbacks such as jack-knifing and so on in the commercial vehicles. Since in the ATC mode no driver's manual brake demand pressure is necessary, it should also be envisaged that the ATC mode enables direct automatic brake control under emergency situations where the driver is unable or incapable of providing the required brake command.

The following passages are provided to explain the general working principle of electropneumatic brake system 300 to the extent necessary.

As can be seen from FIG. 3, solenoid valve 110 is shown in activated state, whereby port 110.1 receiving the pressurized fluid from reservoir 108 is connected to port 110.2. Thus, pressurized fluid from port 110.2 is directly supplied to electronically controlled pressure receiving port 306 at a first side of pressure operated unit 304 of the second embodiment. Hence, in the absence of pressure from brake signal transmitter 104 and/or due to the delay in the receipt of the pressurized fluid from brake signal transmitter 104 at manual pressure receiving port 308, the electropneumatic pressure component that is received from solenoid valve 110 reaches control port 122 of relay valve 124. This activates relay valve 124 to connect supply pressure received via input port 116 or line 116 with output port 132 of relay valve 124.

The remaining function of brake control valve 302 in relation to valves 136, 148, 142, 150, 144, 146, 152 and 154 is same as that of brake control valve 102 explained in conjunction with FIG. 1 above (see in particular the general working principle explained therein). Hence, this is not repeated for the sake of brevity.

FIG. 4 shows a partial cross-sectional view of an electropneumatic pre-control unit EPU2 as a part of brake control valve 302 in accordance with the second embodiment.

Similar to the explanation provided in relation to FIG. 3, there are common elements between electropneumatic pre-control units EPU1 and EPU2. Hence, wherever same reference signs are used for the elements of FIG. 2 and FIG. 4, they refer to the same element. Wherever the differences appear, they are explained in the following passages to the extent necessary.

Contrary to the disclosure provided in relation to FIG. 2, pressure operated unit 304 of the second embodiment of the present disclosure is designed to work in a different way, in particular it is not configured to operate as a non-return valve. According to the present embodiment, the reciprocating structure of pressure operated unit 304 includes a shuttle 402 that is configured to move and close port receiving either the brake pressure reflecting the driver's brake demand pressure component i.e., via manual demand pressure port 202 or the electropneumatic pressure component from solenoid valve 110, in particular via port 110.1 (c.f. FIG. 4).

A general working principle of electro-pneumatic unit EPU2 of the second embodiment of the present disclosure is explained herewith. As the pressure from fluid reservoir 108 (c.f. FIG. 3) enters port 110.1, it is filled temporarily in first intermediary chamber 220. This means that incoming pressure received within first intermediary chamber 220 is not directly transmitted to second intermediary chamber 216 as valve port 212 is blocked by spring-supported member 218. In particular, the vulcanized rubber provided at the central region of spring-supported member 218, wherein the central region is darkly shaded in FIGS. 2 and 4, is positioned directly in contact with port 212 and thereby blocking the pressurized fluid entering from first intermediary chamber 220 to second intermediary chamber 216.

However, when the ECU (not shown in any figures) sends an excitation current to magnetic excitation coil 230, spring-supported member 218 is lifted of port 212 and a fluid connection is established first intermediary chamber 220 and second intermediary chamber 216. Thereafter, the pressure from second intermediary chamber 216 is directed to second actuation chamber or electronically controlled pressure receiving port 306 via connecting port 214 as shown in FIG. 4.

If there is no pressure received simultaneously at port 308, which is for receiving the manual pressure reflecting the driver's demand and is directly connected to brake signal transmitter 104 (not shown in FIG. 4, but refer to FIG. 3), then shuttle 402 moves to block manual pressure port 202. As shuttle 402 moves towards port 202, a connection is established between electronically controlled pressure receiving port or second actuation chamber 306 as shown in FIG. 4 and relay valve control port chamber 122.1. This is because the pressurized air from second actuation chamber 306 is connected via a channel 404, in particular when shuttle 402 has moved towards port 202. As a result, the pressure from relay valve control port chamber 122.1 can be connected with control port 122 of relay valve 124 for activation.

Alternatively and additionally, when the pressure from manual pressure port 202 is also received along with the electronically controlled pressure at second actuation chamber 306, then the pressure from whichever side has a higher magnitude is allowed to reach relay valve control port chamber 122.1 and consequently, relay valve control port 122.

The above description should be considered for illustrative purposes. The scope of the present invention is determined by the claims. Nevertheless, the description and drawings may be used to interpret the claims.

### LIST OF REFERENCE SIGNS (PART OF THE DESCRIPTION)

100—electropneumatic brake system of the first embodiment
102—brake control valve
104—“brake signal transmitter” or “brake signal generator” or “foot brake valve”
104.1—supply pressure inlet port of brake signal transmitter 104
104.2—exhaust port of brake signal transmitter 104
104.3—brake pressure outlet of brake signal transmitter 104
104.4—brake pedal
106—exhaust or relief originating from brake signal transmitter 104 which is connected to the atmosphere
108—fluid reservoir or preferably, air pressure storage unit
110—solenoid valve
110.1—inlet port of solenoid valve 110
110.2—outlet port or channel of solenoid valve 110
110.3—a third port connected to the exhaust of solenoid valve 110
112—pressure operated unit
112.1—manual brake pressure receiving port or pilot line of pressure operated unit 112
112.2—port or line connected to control port 122 or the control chamber of relay valve 124
112.3—an electronically controlled pressure receiving port or actuation chamber of pressure operated unit 112; note that line 112.3 branches away or connected to outlet port 110.2 of solenoid valve 110 and/or branches away or connected to port 112.4 of pressure operated unit 112
112.4—a port or channel or inlet port of pressure operated unit 112 that is connected to brake pressure outlet 104.3 of brake signal transmitter 104
112.5—another port or another inlet port or another channel of pressure operated unit 112 that is connected to outlet port 110.2 of solenoid valve 110
112.6—yet another port or outlet channel of pressure operated unit 112 that is connected to control port 122 of relay valve 124
114—a line connecting fluid reservoir 108 with supply pressure inlet port 104.1 of brake signal transmitter 104
116—input port or inlet port of relay valve 124, and connected to fluid reservoir 108
118—a line connecting fluid reservoir 108 with inlet port 110.1 of solenoid valve 110
120—a line connecting brake pressure outlet 104.3 with port 112.4 of pressure operated unit 112
122—control port of relay valve 124
122.1—relay valve control port chamber (may not be part of relay valve in itself, but chamber 122.1 can be functionally connected to the control chamber of the relay valve)
124—relay valve
128—digital pressure sensor (PWM—Pulse Width Modulated pressure sensor)
130—exhaust line connecting relay valve 124 with exhaust or relief port 134
132—output port of relay valve 124
134—exhaust or relief port
136—first electronically operable inlet control valve
136.1—outlet of first electronically operable inlet control valve 136
136.2—inlet of first electronically operable inlet control valve 136
136.3—exhaust port of first electronically operable inlet control valve 136
138—line connecting output port 132 of relay valve 124 with inlet ports 136.2, 142.1, 146.1 of first electronically operable inlet control valve 136, first electronically operable outlet control valve 142 and second electronically operable outlet control valve 146, respectively, and also connected to inlet port 144.1 of second electronically operable inlet control valve 144
140—line connecting output port 132 of relay valve 124 with inlet ports of first pneumatically operable inlet control valve 148 and second pneumatically operable inlet control valve 152
142—first electronically operable outlet control valve
142.1—inlet or inlet port of first electronically operable outlet control valve 142
142.2—exhaust or exhaust port of first electronically operable outlet control valve 142
142.3—outlet or outlet port of first electronically operable outlet control valve 142
144—second electronically operable inlet control valve
144.1—inlet or inlet port of second electronically operable inlet control valve 144
144.2—exhaust or exhaust port of second electronically operable inlet control valve 144
144.3—outlet or outlet port of second electronically operable inlet control valve 144
146—second electronically operable outlet control valve
146.1—inlet or inlet port of second electronically operable outlet control valve 146
146.2—exhaust or exhaust port of second electronically operable outlet control valve 146
146.3—outlet or outlet port of second electronically operable outlet control valve 146
148—first pneumatically operable inlet control valve
148.1—first pilot control line of first pneumatically operable inlet control valve 148
150—first pneumatically operable outlet valve
150.1—second pilot control line 150.1 of first pneumatically operable outlet valve 150
152—second pneumatically operable inlet valve
152.1—third pilot control line 152.1 associated with second pneumatically operable inlet valve 152
J—pneumatic fluid junctions from where output port 132 of relay valve 124 forks out lines 138, 140 and to inlet port 144.1 of second electronically operable inlet control valve 144
154—second pneumatically operable outlet valve
154.1—fourth pilot control line associated with second pneumatically operable outlet valve 154
156, 158—brake actuators associated with an axle, preferably a rear axle of a vehicle, preferably a commercial vehicle
160—first control line of first pneumatically operable inlet valve 148
162—second control line of or associated with first pneumatically operable outlet valve 150
164—third control line of or associated with second pneumatically operable inlet valve 152
166—fourth control line of or associated with second pneumatically operable outlet valve 154
168—line leading from a junction “J” connecting first and second pneumatically operable outlet valves 150 and 154 with exhaust or relief port 134
170—line connecting first and second pneumatically operable outlet valves 150 and 154 with a junction “J”, which eventually leads to exhaust or relief port 134
172—line leading to brake actuator 156 from first pneumatically operable inlet valve 148
172.1—line connecting brake actuator 156 with first pneumatically operable outlet valve 150
172.2—a first non-modulated pressure outlet
172.3 a second non-modulated pressure outlet
174—line connecting second pneumatically operable inlet valve 152 and brake actuator 158
174.1—line connecting brake actuator 158 with second pneumatically operable outlet valve 154
176—line connecting second pneumatically operable inlet valve 152 with output port 132 of relay valve 124
EPU1—an electropneumatic unit of the first embodiment
202—manual pressure port receiving brake pressure output from brake signal transmitter 104 via its brake pressure outlet 104.3
204—valve seat associated with manual pressure port 202
206—over-molded polymer component
206.1—polymer component of over-molded polymer component 206
206.2—plate, preferably made of plastic, to which polymer component 206.1 is molded over to form over-molded polymer component 206
208—lip associated with polymer component 206.1 of over-molded polymer component 206
210—housing
210.1—insert assembled to housing 210, insert 210.1, for instance, holds parts of pressure operated unit 112
212—valve port
214—port connecting second intermediary chamber 216 and electronically controlled pressure receiving port or actuation chamber 112.3 of pressure operated unit 112
214.1—an arrow mark showing an exemplary direction of flow of pressurized air from second intermediary chamber 216 to electronically controlled pressure receiving port or actuation chamber 112.3
216—second intermediary chamber
218—spring-supported member
220—first intermediary chamber
222—spring
224—inner wall, as a part of solenoid valve 110
226—a (radial) gap formed between inner wall 224 and spring-supported member 218
228—a tubular member of solenoid valve 110 that forms exhaust port or path 232
230—magnetic excitation coil of solenoid valve 110
232—exhaust path or port of solenoid valve 110
234—flexible ingress protection membrane provided at exhaust port or path 232 to prevent any foreign material entering such as water or dirt
236—an exhaust chamber, mainly formed below flexible member 234, but enclosed by an exhaust cap 238
238—exhaust cap
240—pores or holes of exhaust cap 238 that connects exhaust chamber 236 with the atmosphere
242—a region that is formed as a part of air flow path formed between spring-supported member 218 and tubular member 228; this region 242 closes when excitation coil 230 is supplied with the excitation current by the ECU such that no air is exhausted from solenoid valve 110
300—electropneumatic brake system of the second embodiment
302—brake control valve of the second embodiment
304—pressure operated unit of the second embodiment
306—electronically controlled pressure receiving port or second actuation chamber of pressure operated unit 304
308—manual pressure receiving port of pressure operated unit 304
EPU2—electropneumatic pre-control unit of the second embodiment
402—shuttle
404—a channel connecting relay valve control port chamber 122.1 with second actuation chamber 306

1. A brake control valve (102; 302), comprising:
a pneumatic pressure inlet port (120) configured to receive brake pressure representing a driver's brake demand pressure component;
a relay valve (124) having a control port (122), an input port (116), and an output port (132), wherein, based on control pressure received at the control port (122), the relay valve (124) is configured to connect the input port (116) with the output port (132); and
an electropneumatic pre-control unit (EPU1; EPU2), wherein output pressure of the electropneumatic pre-control unit (EPU1; EPU2) is configured to supply the control pressure to the control port (122) of the relay valve (124);
wherein the electropneumatic pre-control unit (EPU1; EPU2) includes a solenoid valve (110) and a pressure operated unit (112; 304), and
wherein the pressure operated unit (112; 304) has a reciprocating structure wherein the pressure operated unit (112; 304) is configured to receive the brake pressure representing the driver's brake demand pressure component from the pneumatic pressure inlet port (120) and the electropneumatic pressure component from the solenoid valve (110), and to supply the control pressure, to the control port (122) of the relay valve (124);
wherein the control pressure supplied to the control port is either the brake demand pressure or the electropneumatic pressure received at the pressure operated unit.

2. The brake control valve (102; 302) according to claim 1, wherein the brake control valve (102; 302) further comprises:
a first pneumatically operable inlet valve (148) having an inlet and an outlet, wherein said outlet is connected to a brake actuator (156), and said inlet is connected to the output port (132) of the relay valve (124),
a first electronically operable inlet control valve (136) having an inlet (136.2), an outlet (136.1), and an exhaust port (136.3), wherein the inlet (136.2) of the first electronically operable inlet control valve (136) is connected to the output port (132) of the relay valve (124) and the outlet (136.1) of the first electronically operable inlet control valve (136) is connected to a first control line (160) of the first pneumatically operable inlet valve (148), and wherein, in an open state, the first electronically operable inlet control valve (136) establishes a pneumatic connection between the inlet (136.2) and the outlet (136.1) of the first electronically operable inlet control valve (136), and in a closed state, the outlet (136.1) of the first electronically operable inlet control valve (136) is connected with the exhaust port (136.3) of the first electronically operable inlet control valve (136),
a first pneumatically operable outlet valve (150) disposed between the brake actuator (156) and a relief port (134), wherein on activation of the first pneumatically operable outlet valve (150) connects the brake actuator (156) and the relief port (134) and
a first electronically operable outlet control valve (142) having an inlet (142.1), an outlet (142.3), and an exhaust port (142.2), wherein the inlet (142.1) of the first electronically operable outlet control valve (142) is connected to the output port (132) of the relay valve (124) and the its outlet (142.3) of the first electronically operable outlet control valve (142) is connected to a second control line (162) of the first pneumatically operable outlet valve (150).

3. The brake control valve (102; 302) according to claim 2, wherein the first pneumatically operable inlet valve (148) includes a first inlet diaphragm, which closes the connection between the output port (132) of the relay valve (124) and the brake actuator (156) when there is no pressure in the first control line (160), and wherein the first pneumatically operable outlet valve (150) includes a first outlet diaphragm, which closes the connection between the brake actuator (156) and the relief port (134) when there is pressure in the second control line (162).

4. The brake control valve (102; 302) according to claim 3, wherein the brake control valve (102; 302) further comprises:
a second pneumatically operable inlet valve (152) having an inlet and an outlet, said outlet being connected to a further brake actuator (158) and said inlet being connected to the output port (132) of the relay valve (124),
a second electronically operable inlet control valve (144) having an inlet (144.1), an outlet (114.3), and an exhaust port (144.2), wherein the inlet (144.1) of the second electronically operable inlet control valve (144) is connected to the output port

(132) of the relay valve (124) and the outlet (144.3) of the second electronically operable inlet control valve (144) is connected to a third control line (164) of the second pneumatically operable inlet valve (152), and wherein, in an open state, the second electronically operable inlet control valve (144) establishes a pneumatic connection between the inlet (144.1) and the outlet (144.3) of the second electronically operable inlet control valve (144), and in a closed state, the outlet (144.3) of the second electronically operable inlet control valve (144) is connected with the its exhaust port (144.2) of the second electronically operable inlet control valve (144),
a second pneumatically operable outlet valve (154) disposed between the brake actuator (158) and the relief port (134), and
a second electronically operable outlet control valve (146) having an inlet (146.1), an outlet (146.3), and an exhaust port (146.2), wherein the inlet (146.1) of the second electronically operable outlet control valve (146) is connected to the output port (132) of the relay valve (124) and the is outlet (146.3) of the second electronically operable outlet control valve (146) is connected to a fourth control line (166) of the second pneumatically operable outlet valve (154).

5. The brake control valve (102; 302) according to claim 4, wherein the second pneumatically operable inlet valve (152) includes a second inlet diaphragm, which closes the connection between the output port (132) of the relay valve (124) and the brake actuator (158) when there is no pressure in the third control line (164), and wherein the second pneumatically operable outlet valve (154) includes a second outlet diaphragm, which closes the connection between the brake actuator (156) and the relief port (134) when there is pressure in the fourth control line (166).

6. The brake control valve (102; 302) according to claim 1, wherein the pressure operated unit (112; 304) includes:
at least one manual pressure receiving port (112.4; 308) at a first side of the pressure operated unit (112; 304) that is either directly or indirectly connected to a brake pressure outlet (104.3) of a brake signal transmitter (104), and at least one electronically controlled pressure receiving port (112.5; 306) at a second side of the pressure operated unit (112; 304), and
wherein the pressure operated unit (112; 304) is configured such that the port that receives the pressure that is higher in magnitude is connected with the control port (122) of the relay valve (124).

7. The brake control valve (102; 302) according to claim 1, wherein the pressure operated unit (112; 304) is a solely pneumatically operated valve with at least three ports and is configured to switch between two positions.

8. The brake control valve (102; 302) according to claim 1, wherein the pressure operated unit (112; 304) is a double check valve or a select-high valve.

9. The brake control valve (102; 302) according to claim 8, wherein the reciprocating structure of the pressure operated unit (112; 304) includes a shuttle (402) that moves and closes the port receiving either the brake pressure representing the driver's brake demand or the electropneumatic pressure from the solenoid valve (110).

10. The brake control valve (102; 302) according to claim 1, wherein the pressure operated unit (112; 304) is a non-return valve and the reciprocating structure is an over-molded polymer component (206), wherein the non-return valve is configured to retain a last achieved position within the pressure operated unit (112; 304) when the solenoid valve (110) is in the open position.

11. The brake control valve (102; 302) according to claim 10, wherein when the solenoid valve (110) is in the closed position in which a the pressure from a fluid reservoir (108) does not reach the pressure operated unit (112), the pressure operated unit (112) is configured to retain a position such that a fluid connection is made between the pneumatic pressure inlet port (120) and the control port (122) of the relay valve (124).

12. The brake control valve (102; 302) according to claim 1, wherein the brake control valve (102; 302) further includes a digital pressure sensor (128) that is configured to provide pulse width modulated signals, and wherein the digital pressure sensor (128) is positioned at the output port (132) of the relay valve (124).

13. The brake control valve (102; 302) according to claim 1, wherein the solenoid valve (110) comprises:
an inlet port (110.1),
a first intermediary chamber (220) that receives the pressurized fluid from a fluid reservoir (108) via the inlet port (110.1),
a spring-supported member (218) configured to close and open a valve port (212) connected to the first intermediary chamber (220), a magnetic excitation coil (230) configured to directly or indirectly move the spring-supported member (218) to close or open the valve port (212), and
a second intermediary chamber (216) that is isolated from the first intermediary chamber (220) when the spring-supported member (218) closes the valve port (212), and
an exhaust port (232) connected to the second intermediary chamber (216) when the spring-supported member (218) closes the valve port (212),
wherein the pressure operated unit (112; 304) includes an actuation chamber (112.3 or 306) that is connectable to the second intermediary chamber

(216)
and wherein, when the first and second intermediary chambers are connected to each other when the pressurized fluid from the first intermediary chamber (220) reaches the second intermediary chamber (216), the solenoid valve (110) blocks the connection between the second intermediary chamber (216) and the exhaust port (232).

14. The brake control valve (102; 302) according to claim 13, wherein the actuation chamber (112.3 or 306) is always connected with the second intermediary chamber (216).

15. The brake control valve (102; 302) according to claim 13, wherein the pressure operated unit (112; 304) is a double check valve or a select-high valve;
wherein the reciprocating structure of the pressure operated unit (112; 304) includes a shuttle (402) that moves and closes the port receiving either the brake pressure representing the driver's brake demand or the electropneumatic pressure from the solenoid valve (110);
wherein the shuttle (402) closes one side of the actuation chamber (306).

16. The brake control valve (102; 302) according to claim 1, wherein the brake control valve (102; 302) is a rear axle modulator valve dedicated to control brakes of a rear axle of a vehicle.

17. The brake control valve (102; 302) claim 1, wherein the brake control valve (102; 302) further includes at least two non-modulated pressure outlets (172.2, 172.3), wherein the at least two non-modulated pressure outlets (172.2, 172.3) receive the brake pressure directly from the output port (132) of the relay valve (124), with no valves in a connecting line originating from the output port (132) of the relay valve (124) and ending at the at least two non-modulated pressure outlets (172.2, 172.3).

18. An electropneumatic brake system (100; 300), preferably, an anti-lock brake system (ABS) including the brake control valve (102; 302) according to claim 1.

19. The electropneumatic brake system (100; 300) of claim 18, wherein the electropneumatic brake system further includes a fluid reservoir (108) that serves as a unified pressurized fluid source for both the driver's brake demand pressure component and the electropneumatic pressure component.

20. The electropneumatic brake system (100; 300) of claim 18, wherein the electropneumatic brake system further includes a first fluid reservoir and a second fluid reservoir, wherein the first fluid reservoir serves as the pressurized fluid source for the driver's brake demand pressure component received directly from a brake signal transmitter (104) at the pneumatic pressure inlet port (120), and wherein the second fluid reservoir serves as the pressurized fluid source for the electropneumatic pressure component received from the solenoid valve (110).

21. The electropneumatic brake system (100; 300) of claim 20, wherein a magnitude of pressure of the pressurized fluid stored in the first fluid reservoir is different than a magnitude of the pressurized fluid stored in the second fluid reservoir.
